(19) United States
(12) Patent Application Publication
(10) Pub. No.: US 2026/0195650 A1
(43) Pub. Date: Jul. 9, 2026

(54) DEVICE AND METHOD USING RELATIVE ONE-STEP APPROACH FOR COVARIATE SHIFT ADAPTATION

(71) Applicant: UNIST(ULSAN NATIONAL INSTITUTE OF SCIENCE AND TECHNOLOGY), Ulsan (KR)

(72) Inventors: Gisoo KIM, Ulsan (KR); Yungmin SUNWOO, Ulsan (KR)

(73) Assignee: UNIST(ULSAN NATIONAL INSTITUTE OF SCIENCE AND TECHNOLOGY), Ulsan (KR)

(21) Appl. No.: 19/439,072

(22) Filed: Jan. 2, 2026

Related U.S. Application Data
(63) Continuation of application No. 19/404,567, filed on Dec. 1, 2025, now abandoned.

(30) Foreign Application Priority Data
Jan. 3, 2025 (KR) 10-2025-0001021
Feb. 24, 2025 (KR) 10-2025-0023701

(51) Int. Cl. G06N 20/00

(52) U.S. Cl. CPC G06N 20/00

(57) ABSTRACT

A device and a method of using a relative one-step approach for covariate shift adaptation. The device and method prevent importance estimation errors from being transmitted to subsequent processes, solve the problem of instability in importance estimation, so as to improve generalization performance, and enable accurate prediction of corresponding labels from given covariates by using a one-step approach that introduces the concept of relative importance.

### CROSS-REFERENCE TO RELATED PATENT APPLICATIONS

This application is a Continuation application of U.S. patent application Ser. No. 19/404,567 (filed on Dec. 1, 2025), which claims priority to Korean Patent Application Nos. 10-2025-0001021 (filed on Jan. 3, 2025) and 10-2025-0023701 (filed on Feb. 24, 2025), which are all hereby incorporated by reference in their entirety.

### BACKGROUND

The present disclosure relates to covariate shift adaptation, and more particularly, to a device and method for covariate shift adaptation using a relative one-step approach that introduces the concept of relative importance to improve generalization performance.

The present disclosure is the result of research conducted with support of the AI Industry-Academia Project Support Project (Project Name: “Development of a Methodology for Predicting Thyroid Ophthalmopathy Robust to Heterogeneity of Eye Images Taken with Various Devices”, Ulsan National Institute of Science and Technology Intramural Project No.: 1.240024.01) conducted from Jan. 1, 2023 to the present, and with support of the Institute of Information & Communication Technology Planning & Evaluation (IITP) with funding from the government (Ministry of Science and ICT) in 2024 (No. 2022-0-00469, Project Name: “Development of Core Technology for Goal-Oriented Reinforcement Learning for Commercialization of Autonomous Drones”).

In supervised learning, it is commonly assumed that training samples and test samples follow the same probability distribution.

However, this universal assumption may not actually hold, and in this case, supervised learning algorithms lose their guarantee of generalization performance. There are various variations that cause a mismatch between the probability distribution of training samples pₜᵣ(x,y) and the probability distribution of test samples pₜₑ(x,y) but the most studied variation is the covariate shift.

Covariate shift occurs when the conditional probability distributions are the same (pₜᵣ(y|x)=pₜₑ(y|x)), in the case in which a covariate x of a label y is given, but the distributions of the covariates x are different (pₜᵣ(x)≠pₜₑ(x)), and exist across a wide range of research areas, including speaker recognition, social media text classification, and brain-computer inference.

Covariate shift adaptation is a research field that eliminates prediction errors caused by covariate shifts when the covariates of a test sample and a training sample are given together. A widely used method is to use importance r(x)=pₜₑ(x)/pₜᵣ(x), which is defined as the ratio of covariate probability distributions.

FIG. 1A is a diagram illustrating a covariate shift adaptation method of a two-step approach of the prior art.

Covariate shift adaptation methods of the prior art adopt a two-step approach that first estimates importance when training data is presented and then performs importance-weighted empirical risk minimization using the estimated importance.

At this time, there are various methods of estimating importance by utilizing given samples in the first step, the importance estimation step. However, as the covariates become more complex and the dimensionality increases, importance estimation becomes unstable, and errors in the importance estimation step are directly propagated to subsequent steps, lowering the performance of a prediction model.

FIG. 1B is a diagram illustrating a covariate shift adaptation method of a one-step approach of the prior art.

As an alternative to overcome the problems of covariate shift adaptation of the two-step approach, a one-step approach was proposed that combines an importance estimation step and an importance-weighted empirical risk minimization step to simultaneously train a prediction model and an importance estimation model.

Here, risk is defined as an expected value for pₜₑ(x,y) of a loss function [symbol] as shown below and is used to evaluate the generalization performance of model f.

$$R ( f ) {=}^{Δ} {𝔼}_{{p}_{te} ( x , y )} [ ℓ ( f ( x ) , y ) ] \qquad [ Equation 1 ]$$

The one-step approach uses the fact that risk has an upper bound J(f,g) defined as follows:

$$J ( f , g ) {=}^{Δ} {{𝔼}_{{p}_{tr} ( x , y )} [ ℓ ( f ( x ) , y ) g ( x ) ]}^{2} + {M}^{2} {𝔼}_{{p}_{tr} ( x )} [ {( g ( x ) - r ( x ) )}^{2} ] \qquad [ Equation 2 ]$$

Here, r denotes importance and M denotes the upper bound of [symbol] .

The one-step approach is to obtain a prediction model f and an importance estimation model g that minimize an upper bound J(f,g), but since J(f,g) cannot be computed in practice, the one-step approach, given a sample

$$S = {\{ ( {x}_{i}^{tr} , {y}_{i}^{tr} ) \}}_{i = 1}^{{n}_{tr}} U {\{ {x}_{i}^{tr} \}}_{i = 1}^{{n}_{te}} ,$$

constructs the following empirical upper bound Ĵ(f,g;S).

$$\hat{J} ( f , g ; S ) {=}^{Δ} {( \frac{1}{{n}_{tr}} {\sum }_{i = 1}^{{n}_{tr}} ℓ ( f ( {x}_{i}^{tr} ) , {y}_{i}^{tr} ) g ( {x}_{i}^{tr} ) )}^{2} + {M}^{2} ( \frac{1}{{n}_{tr}} {\sum }_{i = 1}^{{n}_{tr}} {g ( {x}_{i}^{tr} )}^{2} - \frac{2}{{n}_{te}} {\sum }_{i = 1}^{{n}_{te}} g ( {x}_{i}^{te} ) + C ) \qquad [ Equation 3 ]$$

In the definition of Ĵ(f,g;S), C is a constant unrelated to f and g, so it can be ignored when minimizing Ĵ(f,g;S). The one-step approach searches for \hat{f} and ĝ that minimize this in a function space [symbol] and [symbol] ₊ (a set of functions with non-negative outputs).

$$\hat{f} , \hat{g} = arg {min}_{f ∈ ℱ , g ∈ {𝒢}_{+}} \hat{J} ( f , g ; S ) \qquad [ Equation 4 ]$$

It is assumed that [symbol] (f(x),y)≤M is satisfied for all f and (x,y), [symbol] is the L-lipschitz function, and 0≤g(x)≤G is satisfied for all x. At this time, \hat{f} has the following generalization bound with a probability of 1−δ.

$$\frac{1}{2} {R ( \hat{f} )}^{2} \leq {min}_{f ∈ ℱ , g ∈ 𝒢} I ( f , g ) + 8 MG ( M + G ) ( L {ℜ}_{{n}_{tr}}^{tr} ( ℱ ) + {ℜ}_{{n}_{tr}}^{tr} ( 𝒢 ) ) + 4 {M}^{2} {ℜ}_{{n}_{te}}^{te} ( 𝒢 ) + 10 {M}^{2} {G}^{2} \sqrt{\frac{log 1 / δ}{2}} ( \frac{1}{\sqrt{{n}_{tr}}} + \frac{1}{\sqrt{{n}_{te}}} ) + {M}^{2} {G}^{2} \frac{1}{{n}_{tr}} \qquad [ Equation 5 ]$$

Here,

$${ℜ}_{{n}_{tr}}^{tr} ( ℱ )$$

is used to measure the complexity of [symbol] as the Rademacher complexity of a function space [symbol] for samples drawn from a probability distribution pₜᵣ(x) with a sample size nₜᵣ. The covariate shift adaptation method (two-step approach) of the prior art has a problem in that, as covariates become more complex and their dimensionality increase, importance estimation becomes unstable, and errors in the importance estimation step are fully propagated to subsequent steps, lowering the performance of the prediction model.

In addition, the covariate shift adaptation method (one-step approach) of the prior art departs from the two-step approach and prevents the importance estimation error from being fully transmitted to subsequent processes, but has a problem of instability in importance estimation.

Therefore, there is a need to develop a new covariate shift adaptation technique that can improve generalization performance.

### PRIOR-ART DOCUMENTS

### Patent Documents

(Patent Document 1) Korean Patent No. 10-2389479
(Patent Document 2) Korean Patent No. 10-2382707
(Patent Document 3) Korean Patent Application Publication No. 10-2024-0124391

### SUMMARY

Against this background, one object of embodiments of the present disclosure is to solve the problems of the covariate shift adaptation technology of the prior art, and to provide a device and method using a relative one-step approach for covariate shift adaptation for improving generalization performance by using a relative one-step approach that introduces the concept of relative importance.

Another object of embodiments of the present disclosure is to provide a device and method using a relative one-step approach for covariate shift adaptation that prevents importance estimation errors from being transmitted to subsequent processes, solves the problem of instability in importance estimation, so as to improve generalization performance, and accurately predicts corresponding labels from given covariates by using a one-step approach that introduces the concept of relative importance.

Other objects of the present disclosure are not limited to the purposes mentioned above, and other purposes not mentioned will be clearly understood by those skilled in the art from the description below.

According to an embodiment of the present disclosure, there may be provided a device using a relative one-step approach for covariate shift adaptation, the device including: a data input part configured to input training domain data

$$( {\{ ( {x}_{i}^{tr} , {y}_{i}^{tr} ) \}}_{i = 1}^{{n}_{tr}} )$$

and test domain data

$$( {\{ {x}_{i}^{te} \}}_{i = 1}^{{n}_{te}} ) ;$$

a model configuration and parameter initialization part configured to configure models f and g and initialize parameters; a first update part configured to fix f and α then search for g that minimizes Ĵ_{α}(f,g;S); a second update part configured to fix g and α and then search for f that minimizes Ĵ_{α}(f,g;S); a third update part configured to fix f and g and then search for a that minimizes Ĵ_{α}(f,g;S); and a test domain task performing part configured to perform a test domain task using model f, wherein the device performs covariate shift adaptation using a one-step approach that obtains a prediction model f and an importance estimation model g that minimize an upper bound J(f,g), and a relative one-step approach that uses relative importance to replace the denominator of the importance with q_{α}(x)=αpₜₑ(x)+(1−α)pₜᵣ(x), a∈[0,1], which is a mixed distribution of two probability distributions pₜₑ(x) and pₜᵣ(x).

According to an embodiment of the present disclosure, there may be provided a method of using a relative one-step approach for covariate shift adaptation, the method including: a data input step to input training domain data

$$( {\{ ( {x}_{i}^{tr} , {y}_{i}^{tr} ) \}}_{i = 1}^{{n}_{tr}} )$$

and test domain data

$$( {\{ {x}_{i}^{te} \}}_{i = 1}^{{n}_{te}} ) ;$$

a model configuration and parameter initialization step to configure models f and g and initialize parameters; a first update step to fix f and α and then search for g that minimizes Ĵ_{α}(f,g;S); a second update step to fix B and a and then search for that minimizes Ĵ_{α}(f,g;S); a third update step to fix f and g and then search for α that minimizes Ĵ_{α}(f,g;S); a test domain task performing step to perform a test domain task using model f, and is characterized in that it performs covariate shift adaptation using a one-step approach of obtaining a prediction model f and an importance estimation model g that minimize an upper bound J(f,g), and a relative one-step approach using relative importance that replaces the denominator of the importance with q_{α}(x)=αpₜₑ(x)+(1−α)pₜᵣ(x), α∈[0,1], which is a mixed distribution of two probability distributions pₜₑ(x) and pₜᵣ(x).

A device and method using a relative one-step approach for covariate shift adaptation according to the present disclosure as described above have the following effects.

First, it is possible to improve generalization performance by using a relative one-step approach that introduces the concept of relative importance.

Second, the one-step approach that introduces the concept of relative importance is capable of preventing importance estimation errors from being transmitted to subsequent processes, overcoming the instability problem of importance estimation, improving generalization performance, and enabling accurate prediction of corresponding labels from given covariates.

### BRIEF DESCRIPTION OF THE DRAWINGS

FIG. 1A is a diagram illustrating a covariate shift adaptation method of a two-step approach of the prior art.

FIG. 1B is a diagram illustrating a covariate shift adaptation method of a one-step approach of the prior art.

FIG. 2 is a diagram illustrating a device that uses a relative one-step approach for covariate shift adaptation according to the present disclosure.

FIG. 3 is a flow chart illustrating a method using a relative one-step approach for covariate shift adaptation according to the present disclosure.

FIG. 4 is a graph of covariate shift data of training data and test data.

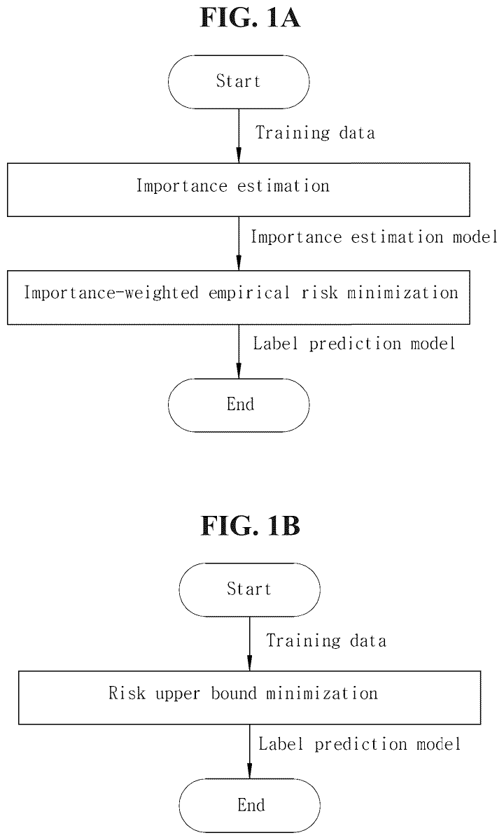

### DETAILED DESCRIPTION

In the following description, a preferred embodiment of a device and method using a relative one-step approach for covariate shift adaptation according to the present disclosure will be described in detail.

The features and advantages of the device and method using the relative one-step approach for covariate shift adaptation according to the present disclosure will become apparent through the detailed description of each embodiment below.

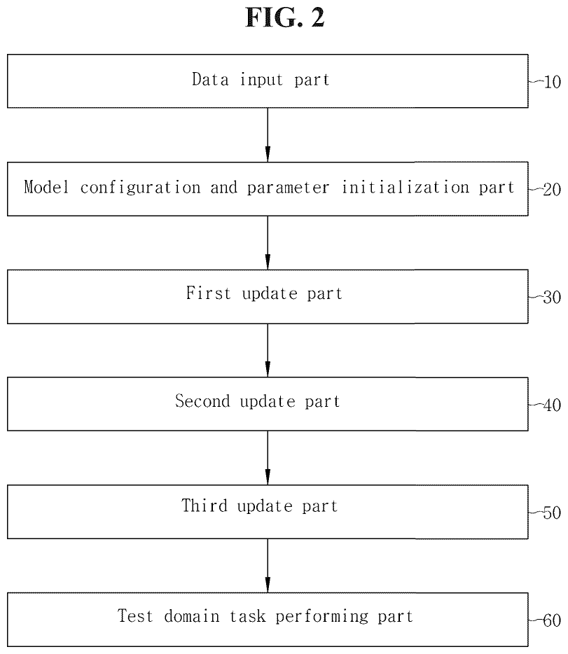

FIG. 2 is a diagram illustrating a device that uses a relative one-step approach for covariate shift adaptation according to the present disclosure.

The terms used in this disclosure are selected from the most widely used general terms available while taking into account the functions of this disclosure, but these may vary depending on the intention of a technician working in the field, precedents, the emergence of new technologies, or the like. Additionally, in certain cases, there are terms arbitrarily selected by the applicant, and in such cases, their meanings will be described in detail in the relevant description of the disclosure. Therefore, the terms used in this disclosure should not be simply defined based on the names of the terms, but should be defined based on the meaning of the terms and the overall contents of this disclosure.

When a part of a specification is said to “include” a component, this does not mean that it excludes other components, but rather that it may include other components, unless otherwise stated. Additionally, terms such as “part”, “unit”, “module”, or the like described in the specification mean a unit that processes at least one function or operation, which may be implemented as hardware or software, or a combination of hardware and software.

In particular, units that process at least one function or operation can be implemented as an electronic device including at least one processor, and at least one peripheral device may be connected to the electronic device depending on a method of processing a function or operation.

The device and method using a relative one-step approach for covariate shift adaptation according to the present disclosure may improve generalization performance by using a relative one-step approach that introduces the concept of relative importance.

To this end, the present disclosure may include a configuration that prevents importance estimation errors from being transmitted to subsequent processes, resolves the instability problem of importance estimation, so as to improve generalization performance, and enables accurate prediction of corresponding labels from given covariates by using a one-step approach that introduces the concept of relative importance.

Relative importance replaces the denominator of importance with q_{α}(x)=αpₜₑ(x)+(1−α)pₜᵣ(x), α∈[0,1], which is a mixed distribution of two probability distributions pₜₑ(x) and pₜᵣ(x), and has the effect of smoothing the existing importance and takes an advantage of making its estimation much more stable.

A two-step covariate shift adaptation scheme using relative importance, called relative importance weighted empirical risk minimizer, has been proposed to use the stability of relative importance estimation naturally, but a one-step covariate shift adaptation scheme that considers relative importance does not yet exist.

The present disclosure proposes a new one-step approach, the relative one-step approach, which introduces the concept of relative importance.

A device using a relative one-step approach for covariate shift adaptation according to the present disclosure includes, as shown in FIG. 2, a data input part 10 that inputs training domain data

$$( {\{ ( {x}_{i}^{tr} , {y}_{i}^{tr} ) \}}_{i = 1}^{{n}_{tr}} )$$

and test domain data

$$( {\{ {x}_{i}^{te} \}}_{i = 1}^{{n}_{te}} ) ,$$

a model configuration and parameter initialization part 20 that configures models f and g and initializes parameters, a first update part 30 that searches for g that minimizes Ĵ_{α}(f,g;S) after fixing f and α, a second update part 40 that searches for f that minimizes Ĵ_{α}(f,g;S) after fixing g and α, a third update part 50 that searches for a that minimizes Ĵ_{α}(f,g;S) after fixing f and g, and a test domain task performing part 60 that performs a test domain task using model f.

A method of using a relative one-step approach for covariate shift adaptation according to the present disclosure is specifically described as follows.

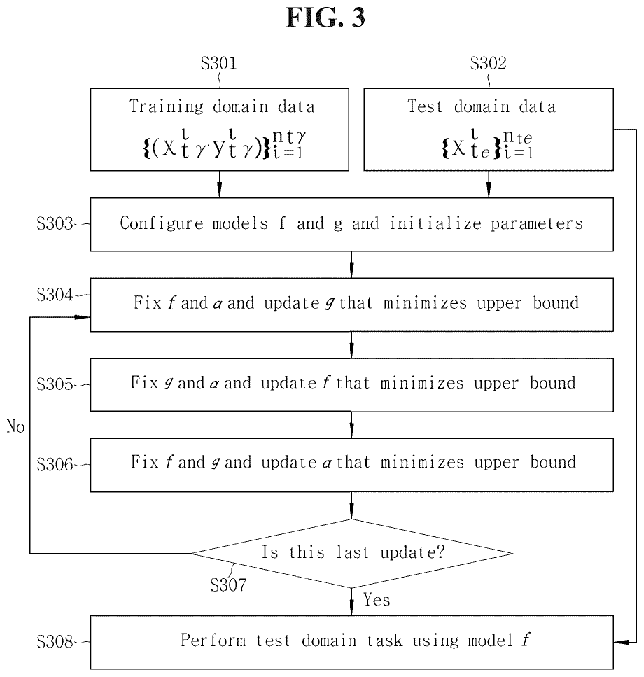

FIG. 3 is a flowchart illustrating a method of using a relative one-step approach for covariate shift adaptation according to the present disclosure.

A method using a relative one-step approach for covariate shift adaptation according to the present disclosure includes, as shown in FIG. 3, a data input step that inputs training domain data

$$( {\{ ( {x}_{i}^{tr} , {y}_{i}^{tr} ) \}}_{i = 1}^{{n}_{tr}} )$$

and test domain data

$$( {\{ {x}_{i}^{te} \}}_{i = 1}^{{n}_{te}} )$$

in steps S301 and S302, a model configuration and parameter initialization step S303 that configures models f and g and initializes parameters, a first update step S304 that searches for g that minimizes Ĵ_{α}(f,g;S) after fixing f and α, a second update step S305 that searches for t that minimizes Ĵ_{α}(f,g;S) after fixing R and c, a third update step S306 that searches for α that minimizes Ĵ_{α}(f,g;S) after fixing f and g, and a test domain task performing step that repeats an optimization process until an iteration condition is satisfied in step S307, and performing a test domain task using model f in step S308.

The relative one-step approach uses the fact that risk has the following upper bound Jₐ(f,g):

$${J}_{α} ( f , g ) {=}^{Δ} {( α M {𝔼}_{{p}_{te} ( x )} [ g ( x ) ] + ( 1 - α ) {𝔼}_{{p}_{tr} ( x , y )} [ ℓ ( f ( x ) , y ) g ( x ) ] )}^{2} + {M}^{2} ( {α𝔼}_{{p}_{te} ( x )} [ {g ( x )}^{2} ] + ( 1 - α ) {𝔼}_{{p}_{tr} ( x )} [ {g ( x )}^{2} ] - 2 {𝔼}_{{p}_{te} ( x )} [ g ( x ) ] ) + {M}^{2} ( {𝔼}_{{p}_{te} ( x )} [ r ( x ) ] + α ( 1 - {e}^{KL [ {p}_{te} ‖ {p}_{tr} ]} ) ) \qquad [ Equation 6 ]$$

Here, r denotes importance, [symbol] denotes a loss function, and M is the upper bound of [symbol] . KL[pᵣₑ∥pₜᵣ] is the Kullback-Leibler divergence, which represents the difference between two probability distributions pₜₑ(x) and pₜᵣ(x).

Similarly, since J_{α}(f,g) cannot be calculated during a training phase, the relative one-step approach utilizes the following empirical upper bound Ĵ_{α}(f,g;S) when the sample

$$S = {\{ ( {x}_{i}^{tr} , {y}_{i}^{tr} ) \}}_{i = 1}^{{n}_{tr}} ⋃ {\{ {x}_{i}^{te} \}}_{i = 1}^{{n}_{te}}$$

is given.

$${\hat{J}}_{α} ( f , g ; S ) {=}^{Δ} {( \frac{α M}{{n}_{te}} {\sum }_{i = 1}^{{n}_{te}} g ( {x}_{i}^{te} ) + \frac{1 - α}{{n}_{tr}} {\sum }_{i = 1}^{{n}_{tr}} ℓ ( f ( {x}_{i}^{tr} ) , {y}_{i}^{tr} ) g ( {x}_{i}^{tr} ) )}^{2} + {M}^{2} ( \frac{α}{{n}_{te}} {\sum }_{i = 1}^{{n}_{te}} {g ( {x}_{i}^{te} )}^{2} + \frac{1 - α}{{n}_{tr}} {\sum }_{i = 1}^{{n}_{tr}} {g ( {x}_{i}^{tr} )}^{2} - \frac{2}{{n}_{te}} {\sum }_{i = 1}^{{n}_{te}} g ( {x}_{i}^{te} ) ) + {M}^{2} ( {𝔼}_{{p}_{te} ( x )} [ r ( x ) ] + α ( 1 - {e}^{KL [ {p}_{te} ‖ {p}_{tr} ]} ) ) \qquad [ Equation 7 ]$$

Similar to the one-step approach, the relative one-step approach searches for \hat{f}∈ [symbol] , ĝ∈ [symbol] ₊, and \hat{α}∈[0,1) that minimize Ĵ_{α}(f,g;S).

$$\hat{f} , \hat{g} , \hat{α} = arg {min}_{f ∈ ℱ , ℊ ∈ {𝒢}_{+} , α ∈ [ 0 , 1 ]} {\hat{J}}_{𝒶} ( f , g ; S ) \qquad [ Equation 8 ]$$

As before, it is assumed that [symbol] (f(x),y)≤M is satisfied for all f and (x,y), [symbol] is an L-lipschitz function, and 0≤g(X)≤G is satisfied for all x.

In addition, f, g and α that minimize J_{α}(f,g) are denoted as f*, g*, α*, and n̅=min(nₜᵣ,nₜₑ).

At this time, \hat{f} has the following generalization bound with a probability of 1−δ.

$$\frac{1}{2} {R ( \hat{f} )}^{2} \leq {J}_{a} * ( {f}^{*} , {g}^{*} ) + ( \hat{α} 8 {M}^{2} G + 4 {M}^{2} ) {ℜ}_{{n}_{te}}^{te} ( 𝒢 ) + ( 1 - \hat{α} ) ( 4 MG ( 2 M + G ) L {ℜ}_{{n}_{tr}}^{tr} ( ℱ ) + 8 MG ( M + G ) {ℜ}_{{n}_{tr}}^{tr} ( 𝒢 ) ) + \frac{{α}^{* 2} {M}^{2} {G}^{2}}{{n}_{te}} + \frac{{( 1 - {α}^{*} )}^{2} {M}^{2} {G}^{2}}{{n}_{tr}} + \frac{( 28 + \sqrt{34} ) {M}^{2} {G}^{2}}{\sqrt{\overline{n}}} \sqrt{\frac{log 4 / δ}{2}} + 2 ( 16 {M}^{2} G {ℜ}_{{n}_{te}}^{te} ( 𝒢 ) + 12 MG ( 2 M + G ) L {ℜ}_{{n}_{tr}}^{tr} ( ℱ ) + 8 MG ( 2 M + 3 G ) {ℜ}_{{n}_{tr}}^{tr} ( 𝒢 ) ) \qquad [ Equation 9 ]$$

To verify the theoretical superiority of the relative one-step approach, the generalization upper bounds of the relative one-step approach and the one-step approach are compared using examples as follows.

When [symbol] and [symbol] are sets of functions that are linear in the parameters whose norm is bounded, the Rademaker complexities of [symbol] and [symbol] may be expressed as [symbol] (1/\sqrt{n̅}.

By combining this fact with the generalization bound of the one-step approach and the relative one-step approach, the following is obtained with a probability of 1−δ.

$$( one - step approach ) \frac{1}{2} {R ( \hat{f} )}^{2} \leq {min}_{f , g} J ( f , g ) + O ( \sqrt{\frac{1}{\overline{n}} log \frac{1}{δ}} ) , \qquad [ Equation 10 ]$$

$$( Relative one - step approach ) \frac{1}{2} R {( \hat{f} )}^{2} \leq {min}_{f , g , α} {J}_{α} ( f , g ) + O ( \sqrt{\frac{1}{\overline{n}} log \frac{1}{δ}} )$$

Here, it is identified that the generalization performance of the relative one-step approach is superior, since the following holds.

$${min}_{f , g} J ( f , g ) \geq {min}_{f , g , α} {J}_{α} ( f , g ) \qquad [ Equation 11 ]$$

Furthermore, the present disclosure presents the following theoretical result. When n̅>2 has the following generalization bound with a probability of

$$1 - \frac{32}{\sqrt{170} {n}^{2} \sqrt{log \text{?}}} - \frac{1}{{n}^{2} .}$$

$$\text{?} \text{indicates text missing or illegible when filed}$$

$$\frac{1}{2} {R ( \hat{f} )}^{2} \leq {J}_{a} * ( {f}^{*} , {g}^{*} ) + ( \hat{α} 8 {M}^{2} G + 4 {M}^{2} ) {ℛ}_{{n}_{te}}^{te} ( 𝒢 ) + ( 1 - \hat{α} ) ( 4 MG ( 2 M + G ) L {ℜ}_{{n}_{tr}}^{tr} ( ℱ ) + 8 MG ( M + G ) {ℜ}_{{n}_{tr}}^{tr} ( 𝒢 ) ) + \frac{{α}^{* 2} {M}^{2} {G}^{2}}{{n}_{te}} + \frac{{( 1 - {α}^{*} )}^{2} {M}^{2} {G}^{2}}{{n}_{tr}} + \sqrt{34} ( \sqrt{5} + 1 ) {M}^{2} {G}^{2} \sqrt{\frac{log \overline{n}}{\overline{n}}} \text{?} \qquad [ Equation 12 ]$$

$$\text{?} \text{indicates text missing or illegible when filed}$$

As n̅ increases, the above-described generalization bound approaches the minimum of J_{α}(f,g) with a convergence rate of

$$O ( \sqrt{\frac{log \overline{n}}{\overline{n}}} ) ,$$

and thus although it decreases more slowly than an existing generalization bound, it may have a smaller value in the situation where n̅ is not large enough.

\hat{f}, ĝ, and \hat{α} that minimize Ĵ_{α}(f,g;S) are computed through an alternating minimization scheme. This optimization method finds \hat{f}, ĝ, and \hat{α} by repeating the following process until a given iteration termination condition is satisfied.
(1) fix f and α, and then search for g that minimizes Ĵ_{α}(f,g;S)
(2) fix f and α, and then search for f that minimizes Ĵ_{α}(f,g;S)
(3) fix f and g, and then search for a that minimizes Ĵ_{α}(f,g;S)

f and g are functions that are linear in the parameters as follows, and the parameters are θ∈ [symbol] and β∈ [symbol] .

$$f ( x ) = {θ}^{T} ϕ ( x ) , g ( x ) = {β}^{T} ψ ( x ) \qquad [ Equation 13 ]$$

Here, φ and ψ are basis functions.

Using this, it is defined as follows.

$$ℓ {=}^{Δ} {[ ℓ ( f ( {x}_{1}^{tr} ) , {y}_{1}^{tr} ) , ℓ ( f ( {x}_{2}^{tr} ) , {y}_{2}^{tr} ) , … , ℓ ( f ( {x}_{{n}_{tr}}^{tr} ) , {y}_{{n}_{tr}}^{tr} ) ]}^{T} \qquad [ Equation 14 ]$$

$$Φ {=}^{Δ} {[ ϕ ( {x}_{1}^{tr} ) , ϕ ( {x}_{2}^{tr} ) , … , ϕ ( {x}_{{n}_{tr}}^{tr} ) ]}^{T} \text{?}$$

$${Ψ}_{tr} {=}^{Δ} {[ ψ ( {x}_{1}^{tr} ) , ψ ( {x}_{2}^{tr} ) , … , ψ ( {x}_{{n}_{tr}}^{tr} ) ]}^{T} \text{?}$$

$${y}_{tr} {=}^{Δ} {[ {y}_{1}^{tr} , {y}_{2}^{tr} , … , {y}_{{n}_{tr}}^{tr} ]}^{T} \text{?}$$

$${u}^{T} {=}^{Δ} \frac{α M}{{n}_{te}} {j}^{T} {Ψ}_{te} + \frac{1 - α}{{n}_{tr}} {ℓ}^{T} {Ψ}_{tr} \text{?}$$

$$\text{?} \text{indicates text missing or illegible when filed}$$

Here, j denotes a vector of ones.

If it is assumed that a loss function [symbol] is a squared error, a closed solution may be at each step of the alternating minimization as follows.

$$\hat{β} = {( {uu}^{T} + \frac{α {M}^{2}}{{n}_{te}} {Ψ}_{te}^{T} {Ψ}_{te} + \frac{( 1 - α ) {M}^{2}}{{n}_{tr}} {Ψ}_{tr}^{T} {Ψ}_{tr} + {λ}_{g} I )}^{- 1} \frac{{M}^{2}}{{n}_{te}} {Ψ}_{te}^{T} j \text{?} \qquad [ Equation 15 ]$$

$$\hat{θ} = {( {Φ}^{T} W Φ + {λ}_{f} {n}_{tr} I )}^{- 1} {Φ}^{T} {Wy}_{tr} \text{?}$$

$$\hat{α} = \frac{{M}^{2}}{2} \frac{{β}^{T} ( \frac{1}{{n}_{tr}} {Ψ}_{tr}^{T} {Ψ}_{tr} - \frac{1}{{n}_{te}} {Ψ}_{te}^{T} {Ψ}_{te} ) β - 1 + \text{?} [ {p}_{te} \vert \vert {p}_{tr} ]}{{( \frac{M}{{n}_{te}} {j}^{T} {Ψ}_{te} β - \frac{1}{{n}_{tr}} {ℓ}^{T} {Ψ}_{tr} β )}^{2}} - \frac{\frac{1}{{n}_{tr}} {ℓ}^{T} {Ψ}_{tr} β}{\frac{M}{{n}_{te}} {j}^{T} {Ψ}_{te} β - \frac{1}{{n}_{tr}} {ℓ}^{T} {Ψ}_{tr} β}$$

$$\text{?} \text{indicates text missing or illegible when filed}$$

Here, λ_{g} and λ_{f} are regularization parameters that determine the strength of regularization, I is the identity matrix of an appropriate size, and

$$W = diag ( g ( {x}_{1}^{tr} ) , g ( {x}_{1}^{tr} ) , … , g ( {x}_{{n}_{tr}}^{tr} ) ) .$$

[symbol] [pₜₑ∥pₜᵣ] is an estimate of KL[pₜₑ∥pₜᵣ]. Finally, since g∈ [symbol] ₊ and α∈[0,1), we adjust \hat{β} and \hat{α} as follows.

$$\hat{β} = max ( \hat{β} , 0 ) \text{?} \qquad [ Equation 16 ]$$

$$\hat{α} = min ( max ( \hat{α} , 0 ) , 0.99 )$$

$$\text{?} \text{indicates text missing or illegible when filed}$$

Therefore, the optimization algorithm in the present disclosure is as follows.

TABLE 1
Algorithm 1 Alternating minimization

```
  1: θ₀ ← an arbitrary b_{f}-dimensional vector
  2: α₀ ← an arbitrary value in [0, 0.99]
  3: λ_{f} ← a positive l₂-regularization parameter
  4: λ_{g} ← a positive l₂-regularization parameter
$5 : {I}_{0} ← {[ ℓ ( {θ}_{0}^{T} ϕ ( {x}_{1}^{\text{?}} ) , {y}_{1}^{\text{?}} ) , … , ℓ ( {θ}_{0}^{T} ϕ ( {x}_{\text{?}}^{\text{?}} ) , {y}_{\text{?}}^{\text{?}} ) ]}^{T}$
  6: for t = 0, ... , T − 1do
$7 : {u}_{\text{?}} ← {( \frac{{a}_{\text{?}} M}{\text{?}} {j}^{T} {Ψ}_{\text{?}} + \frac{1 - \text{?}}{\text{?}} {\text{?}}_{\text{?}}^{\text{?}} {Ψ}_{\text{?}} )}^{T}$
$8 : {β}_{l + 1} ← {( {u}_{\text{?}} {u}_{\text{?}}^{T} + \frac{{a}_{\text{?}} {M}^{2}}{\text{?}} {Ψ}_{\text{?}}^{T} {Ψ}_{\text{?}} + \frac{( 1 - {a}_{\text{?}} ) {M}^{2}}{\text{?}} {Ψ}_{\text{?}}^{T} {Ψ}_{\text{?}} {λ}_{\text{?}} I )}^{- 1} \frac{{M}^{2}}{\text{?}} {Ψ}_{\text{?}}^{T} j$
  9: βₗ₊₁ ← max{0, βₗ₊₁}
$10 : {w}_{\text{?}}^{\text{?}} ← {β}_{\text{?}}^{T} ψ ( {x}_{\text{?}}^{\text{?}} ) , i = 1 , … , {n}_{\text{?}}$
11: if l_{UB} is the squared loss then
12: θₗ₊₁ ← Φ^{T}Wₗ₊₁ Φ + λ_{f}nₗᵣI)⁻¹Φ^{T}Wₗ₊₁yₗᵣ
$13 : where {W}_{i + 1} = diag ( {w}_{1}^{\text{?}} , … , {w}_{\text{?}}^{\text{?}} ) and y = {[ {y}_{1}^{\text{?}} , … , {y}_{\text{?}}^{\text{?}} ]}^{T}$
14: else
$15 : {θ}_{\text{?} + 1} ← arg {min}_{θ} \frac{1}{\text{?}} {\sum }_{i = 1}^{\text{?}} {w}_{\text{?}}^{i + 1} ℓ ( {θ}^{T} ϕ ( {x}_{i}^{\text{?}} ) , {y}_{i}^{\text{?}} ) + {λ}_{\text{?}} {θ}^{T} θ$
16: end if
$17 : {\text{?}}_{\text{?}} ← {[ ℓ ( {θ}_{\text{?}}^{T} ϕ ( {x}_{1}^{\text{?}} ) , {y}_{1}^{\text{?}} ) , … , ℓ ( {θ}_{\text{?}}^{T} ϕ ( {x}_{\text{?}}^{\text{?}} ) , {y}_{\text{?}}^{\text{?}} ) ]}^{T}$
$18 : {\text{?}}_{\text{?}} ← \frac{{M}^{2}}{2} \frac{{β}_{\text{?}}^{\text{?}} ( \frac{1}{\text{?}} {Ψ}_{\text{?}}^{\text{?}} - \frac{1}{\text{?}} {Ψ}_{\text{?}}^{\text{?}} {Ψ}_{\text{?}} ) {β}_{\text{?}} - 1 + KL \text{?}}{{( \frac{M}{\text{?}} {\text{?}}^{\text{?}} {Ψ}_{\text{?}} {β}_{\text{?}} - \frac{1}{\text{?}} {\text{?}}_{\text{?}}^{T} {Ψ}_{\text{?}} {β}_{\text{?}} )}^{2}} - \frac{\frac{1}{\text{?}} {\text{?}}_{\text{?}}^{T} {Ψ}_{\text{?}} {β}_{\text{?}}}{\frac{M}{\text{?}} {\text{?}}^{T} {Ψ}_{\text{?}} {β}_{\text{?}} - \frac{1}{\text{?}} {\text{?}}_{\text{?}}^{T} {Ψ}_{\text{?}} {β}_{\text{?}}}$
19: [symbol]   ₁₊₁ ← min{max{0, a₁₊₁}, 0.99}
20: end for [symbol]
indicates data missing or illegible when filed
```

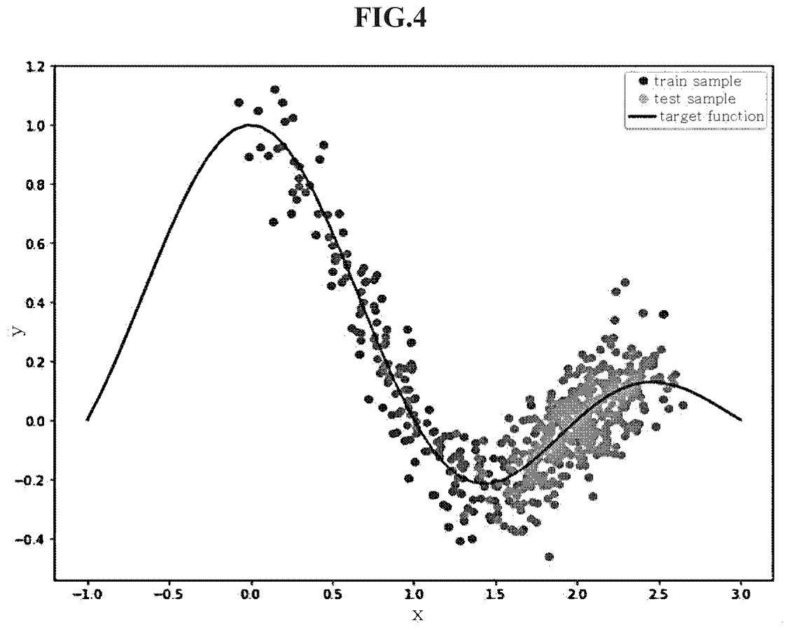

FIG. 4 is a graph of covariate shift data of training data and test data.

FIG. 4 shows data with covariate shift used in the experiment to evaluate the performance of the algorithm.

The covariates of the training and test data are drawn from the following probability distributions.

$${p}_{tr} ( x ) = 𝒩 ( 1 , {0.5}^{2} ) , {p}_{te} ( x ) = 𝒩 ( 2 , {0.25}^{2} ) \qquad [ Equation 17 ]$$

The labels corresponding to the covariates are given as follows.

$$y = sin c ( x ) + ϵ \qquad [ Equation 18 ]$$

Here, ϵ is random noise, which follows the probability distribution [symbol] (0,0.1²), and sinc(x)=sin(πr)/πx.

In addition to the training and test data, evaluation data is drawn from the same probability distribution as the test data to evaluate the performance of a trained model.

The prediction model f and the importance estimation model B are linear functions, and a Gaussian kernel is selected as a basis function. At this time, the purpose of the covariate shift adaptation models is to accurately predict corresponding labels from given covariates of the evaluation data, and the performance is evaluated based on a mean squared error.

In the two-step approach, the hyper-parameters, such as the regularization parameter and the Gaussian kernel width, are determined to have optimal values through cross-validation, and in particular, the hyper-parameters associated with the model 1 are determined through importance-weighted cross-validation.

On the other hand, in the one-step approach, the regularization parameter is determined based on cross-validation, but the Gaussian kernel width is determined based on a median heuristic scheme.

For a fair comparison, we also present the results of applying the empirical median technique to the two-step approaches.

The table below presents the average results of 100 experiments.

TABLE 2

| Methods | MSE (SD) |
|---|---|
| ERM | 0.0208 (0.0036) |
| ERM (median) | 0.0141 (0.0033) |
| IWERM | 0.0129 (0.0028) |
| IWERM (median) | 0.0124 (0.0023) |
| EIWERM | 0.0130 (0.0028) |
| EIWERM (median) | 0.0124 (0.0022) |
| RIWERM | 0.0113 (0.0011) |
| RIWERM (median) | 0.0117 (0.0010) |
| One-step | 0.0121 (0.0012) |
| Relative One-step | 0.0112 (0.0006) |

In the experiments, it is identified that the relative one-step approach has the best generalization performance, which provides evidence that the relative one-step approach is promising.

The present disclosure proposes a relative one-step approach that introduces the concept of relative importance to prevent importance estimation errors in a two-step approach from being fully transmitted to subsequent processes, and further improve the problem of instability in importance estimation. It has been theoretically proven and experimentally supported that its performance may be improved over that of the existing one-step approach.

The device and method for covariate shift adaptation according to the present disclosure described above may improve generalization performance by using a relative one-step approach that introduces the concept of relative importance, and may prevent importance estimation errors from being transmitted to subsequent processes, may solve the problem of instability in importance estimation so as to improve generalization performance, and may enable accurate prediction of corresponding labels from given covariates by using a one-step approach that introduces the concept of relative importance.

As described above, it will be understood that the present disclosure may be implemented in modified forms without departing from the essential features of the present disclosure.

Therefore, the specified embodiments should be considered in an illustrative sense rather than a restrictive sense, and the scope of the present disclosure is indicated by the claims rather than the foregoing descriptions, and all differences within the scope equivalent thereto should be construed as being included in the present disclosure.

### EXPLANATION OF SYMBOLS

10. Data input part
20. Model configuration and parameter initialization part
30. First update part
40. Second update part
50. Third update part
60. Test domain task performing part

1. A device for using a relative one-step approach for covariate shift adaptation, the device comprising:
a data input part configured to input training domain data
$$( {\{ ( {x}_{i}^{tr} , {y}_{i}^{tr} ) \}}_{i = 1}^{{n}_{tr}} )$$
and test domain data
$$( . {\{ {x}_{i}^{te} \}}_{i = 1}^{{n}_{te}} ) ;$$
a model configuration and parameter initialization part configured to configure models f and g and initialize a parameter;
a first update part configured to fix f and a and then search for g that minimizes Ĵ_{α}(f,g;S);
a second update part configured to fix a and a and then search for f that minimizes Ĵ_{α}(f,g;S);
a third update part configured to fix f and g and then search for rt that minimizes Ĵ_{α}(f,g;S); and
a test domain task performing part configured to perform a test domain task using model f,
wherein the device performs covariate shift adaptation using a relative one-step approach that uses relative importance that replaces a denominator of importance with q_{α}(x)=αpₜₑ(1−α)pₜᵣ(x), α∈[0,1] that is a mixed distribution of two probability distributions pₜₑ(x) and pₜᵣ(x), and a one-step approach that obtains a prediction model f and an importance estimation model g that minimize an upper bound J(f,g).

2. The device according to claim 1, wherein the relative one-step approach uses the fact that risk has the following upper bound J_{α}(f,g) and
$${J}_{α} ( f , g ) {=}^{Δ} {( α M {𝔼}_{{p}_{te} ( x )} [ g ( x ) ] + ( 1 - α ) {𝔼}_{{p}_{tr} ( x , y )} [ ℓ ( f ( x ) , y ) g ( x ) ] )}^{2} + {M}^{2} ( α \text{?} [ {g ( x )}^{2} ] + ( 1 - α ) {𝔼}_{{p}_{tr} ( x )} [ {g ( x )}^{2} ] - 2 {𝔼}_{{p}_{te} ( x )} [ g ( x ) ] ) + {M}^{2} ( {𝔼}_{{p}_{te} ( x )} [ r ( x ) ] + α ( 1 - {e}^{KL [ {p}_{te} \vert \vert {p}_{tr} ]} ) ) \text{?}$$
$$\text{?} \text{indicates text missing or illegible when filed}$$
wherein r denotes importance, [symbol] denotes a loss function, M denotes an upper bound of [symbol] , and KL[pₜₑ∥pₜᵣ] denotes a Kullback-Leibler divergence indicating a difference between two probability distributions pₜₑ(x) and pₜᵣ(x).

3. The device according to claim 2, wherein the risk is defined as an expected value of pₜₑ(x,y) of the loss function, [symbol]
$$R ( f ) {=}^{Δ} \text{?} [ ℓ ( f ( x ) , y ) ]$$
and is used to evaluate generalization performance of the model f.

4. The device according to claim 2, wherein, when a sample
$$S = {\{ ( {x}_{i}^{tr} , {y}_{i}^{tr} ) \}}_{i = 1}^{{n}_{tr}} U {\{ {x}_{i}^{te} \}}_{i = 1}^{{n}_{te}} is given ,$$
the relative one-step approach calculates and utilizes an empirical upper limit Ĵ_{α}(f,g;S), where
$${\hat{J}}_{α} ( f , g ; S ) {=}^{Δ} {( \frac{α M}{{n}_{te}} {\sum }_{i = 1}^{{n}_{te}} g ( {x}_{i}^{te} ) + \frac{1 - α}{{n}_{tr}} {\sum }_{i = 1}^{{n}_{tr}} ℓ ( f ( {x}_{i}^{tr} ) , {y}_{i}^{tr} ) g ( {x}_{i}^{tr} ) )}^{2} + {M}^{2} ( \frac{α}{{n}_{te}} {\sum }_{i = 1}^{{n}_{te}} {g ( {x}_{i}^{te} )}^{2} + \frac{1 - α}{{n}_{tr}} {\sum }_{i = 1}^{{n}_{tr}} {g ( {x}_{i}^{tr} )}^{2} - \frac{2}{{n}_{te}} {\sum }_{i = 1}^{{n}_{te}} g ( {x}_{i}^{te} ) ) + {M}^{2} ( \text{?} [ r ( x ) ] + α ( 1 - {e}^{KL [ {p}_{te} \vert \vert {p}_{tr} ]} ) ) \text{?}$$
$$\text{?} \text{indicates text missing or illegible when filed}$$

5. The device according to claim 4, wherein the relative one-step approach searches for \hat{f}∈ [symbol] , ĝ∈ [symbol] ₊, and \hat{α}∈[0,1) that minimize Ĵ_{α}(f,g;S),
and is defined as.
$$\hat{f} , \hat{g} , \hat{α} = arg {min}_{f ∈ ℱ , g ∈ {𝒢}_{+} , α ∈ [ 0 , 1 ]} {\hat{J}}_{α} ( f , g ; S ) .$$

6. The device according to claim 5, wherein, on the assumption that [symbol] (f(x),y)≤M is satisfied for all f and (x,y), [symbol] is an L-lipschitz function, and 0≤g(x)≤G is satisfied for all x,
when f, g and α that minimize J_{α}(f,g) are denoted as f*, g*, α*, and n̅=min(nₜᵣ, nₜₑ), a generalization bound of \hat{f} is
$$\frac{1}{2} {R ( \hat{f} )}^{2} \leq {J}_{α} * ( {f}^{*} , {g}^{*} ) + ( \hat{α} 8 {M}^{2} G + 4 {M}^{2} ) {ℜ}_{{n}_{te}}^{te} ( 𝒢 ) + ( 1 - \hat{α} ) ( 4 MG ( 2 M + G ) L {ℜ}_{{n}_{tr}}^{tr} ( ℱ ) + 8 MG ( M + G ) {ℜ}_{{n}_{tr}}^{tr} ( 𝒢 ) ) + \frac{{α}^{* 2} {M}^{2} {G}^{2}}{{n}_{te}} + \frac{{( 1 - {α}^{*} )}^{2} {M}^{2} {G}^{2}}{{n}_{tr}} + \frac{( 28 + \sqrt{34} ) {M}^{2} {G}^{2}}{\sqrt{\overline{n}}} \sqrt{\frac{log 4 / δ}{2}} + 2 ( 16 {M}^{2} G {ℜ}_{{n}_{te}}^{te} ( 𝒢 ) + 12 MG ( 2 M + G ) L {ℜ}_{{n}_{tr}}^{tr} ( ℱ ) + 8 MG ( 2 M + 3 G ) {ℜ}_{{n}_{tr}}^{tr} ( 𝒢 ) )$$
with a probability of 1−δ.

7. A method of using a relative one-step approach for covariate shift adaptation, the method comprising:
a data input step to input training domain data
$$( . {\{ ( {x}_{i}^{tr} , {y}_{i}^{tr} ) \}}_{i = 1}^{{n}_{tr}} )$$
and test domain data
$${\{ {x}_{i}^{te} \}}_{i = 1}^{{n}_{te}} ) ;$$
a model configuration and parameter initialization step to configure models f and g and initialize a parameter;
a first update step to fix f and α and then search for g that minimizes Ĵ_{α}(f,g;S);
a second update step to fix g and α and then search for f that minimizes Ĵ_{α}(f,g;S);
a third update step to fix f and g and then search for a that minimizes Ĵ_{α}(f,g;S); and
a test domain task performing step to perform a test domain task using model f,
wherein the method performs covariate shift adaptation using a relative one-step approach that uses relative importance that replaces a denominator of importance with q_{α}(x)=αpₜₑ(x)+(1−α)pₜᵣ(x), α∈[0,1] that is a mixed distribution of two probability distributions pₜₑ(x) and pₜᵣ(x), and a one-step approach that obtains a prediction model f and an importance estimation model g that minimize an upper bound J(f,g).

8. The method according to claim 7, wherein the relative one-step approach uses the fact that risk has the following upper bound J_{α}(f,g), and
$${J}_{α} ( f , g ) {=}^{Δ} {( α M {𝔼}_{{p}_{te} ( x )} [ g ( x ) ] + ( 1 - α ) {𝔼}_{{p}_{tr} ( x , y )} [ ℓ ( f ( x ) , y ) g ( x ) ] )}^{2} + {M}^{2} ( {α𝔼}_{{p}_{te} ( x )} [ {g ( x )}^{2} ] + ( 1 - α ) {𝔼}_{{p}_{tr} ( x )} [ {g ( x )}^{2} ] - 2 \text{?} [ g ( x ) ] ) + {M}^{2} ( \text{?} [ r ( x ) ] + α ( 1 - {e}^{KL [ {p}_{te} \vert \vert {p}_{tr} ]} ) ) \text{?}$$
$$\text{?} \text{indicates text missing or illegible when filed}$$
wherein r denotes importance, [symbol] denotes a loss function, M denotes an upper bound of [symbol] , and KL[pₜₑ∥pₜᵣ] denotes a Kullback-Leibler divergence indicating a difference between two probability distributions pₜₑ(x) and pₜᵣ(x).

9. The method according to claim 8, wherein the risk is defined as an expected value of pₜₑ(x,y) of the loss function [symbol] ,
$$R ( f ) {=}^{Δ} \text{?} [ ℓ ( f ( x ) , y ) ] ,$$
and is used to evaluate generalization performance of the model f.

10. The method according to claim 8, wherein, when a sample
$$S = {\{ ( {x}_{i}^{tr} , {y}_{i}^{tr} ) \}}_{i = 1}^{{n}_{tr}} U {\{ {x}_{i}^{te} \}}_{i = 1}^{{n}_{te}}$$
the relative one-step approach calculates and utilizes an empirical upper limit Ĵ_{α}(f,g;S), where
$${\hat{J}}_{α} ( f , g ; S ) {=}^{Δ} {( \frac{α M}{{n}_{te}} {\sum }_{i = 1}^{{n}_{te}} g ( {x}_{i}^{te} ) + \frac{( 1 - α )}{{n}_{tr}} {\sum }_{i = 1}^{{n}_{tr}} ℓ ( f ( {x}_{i}^{tr} ) , {y}_{i}^{tr} ) g ( {x}_{i}^{tr} ) )}^{2} + {M}^{2} ( \frac{α}{{n}_{te}} {\sum }_{i = 1}^{{n}_{te}} {g ( {x}_{i}^{te} )}^{2} + \frac{1 - α}{{n}_{tr}} {\sum }_{i = 1}^{{n}_{tr}} {g ( {x}_{i}^{tr} )}^{2} - \frac{2}{{n}_{te}} {\sum }_{i = 1}^{{n}_{te}} g ( {x}_{i}^{te} ) ) + {M}^{2} ( \text{?} [ r ( x ) ] + α ( 1 - {e}^{KL [ {p}_{te} \vert \vert {p}_{tr} ]} ) ) \text{?}$$
$$\text{?} \text{indicates text missing or illegible when filed}$$

11. The method according to claim 10, wherein the relative one-step approach searches for \hat{f}∈ [symbol] , ĝ∈ [symbol] ₊, and \hat{α}∈[0,1) that minimize Ĵ_{α}(f,g;S),
and are defined as,
$$\hat{f} , \hat{g} , \hat{α} = arg {min}_{f ∈ ℱ , g ∈ {𝒢}_{+} , α ∈ [ 0 , 1 ]} {\hat{J}}_{α} ( f , g ; S ) .$$

12. The method according to claim 11, wherein, on the assumption that [symbol] (f(x),y)≤M is satisfied for all f and (x,y), [symbol] is an L-lipschitz function, and 0≤g(x)≤G is satisfied for all x,
when f, g and α that minimize J_{α}(f,g) are denoted as f*, g*, α*, and n̅=min(nₜᵣ,nₜₑ), a generalization bound of \hat{f} is
$$\frac{1}{2} {R ( \hat{f} )}^{2} \leq {J}_{α} * ( {f}^{*} , {g}^{*} ) + ( \hat{α} 8 {M}^{2} G + 4 {M}^{2} ) {ℜ}_{{n}_{te}}^{te} ( 𝒢 ) + ( 1 - \hat{α} ) ( 4 MG ( 2 M + G ) L {ℜ}_{{n}_{tr}}^{tr} ( ℱ ) + 8 MG ( M + G ) {ℜ}_{{n}_{tr}}^{tr} ( 𝒢 ) ) + \frac{{α}^{* 2} {M}^{2} {G}^{2}}{{n}_{te}} + \frac{{( 1 - {α}^{*} )}^{2} {M}^{2} {G}^{2}}{{n}_{tr}} + \frac{( 28 + \sqrt{34} ) {M}^{2} {G}^{2}}{\sqrt{\overline{n}}} \sqrt{\frac{log 4 / δ}{2}} + 2 ( 16 {M}^{2} G {ℜ}_{{n}_{te}}^{te} ( 𝒢 ) + 12 MG ( 2 M + G ) L {ℜ}_{{n}_{tr}}^{tr} ( ℱ ) + 8 MG ( 2 M + 3 G ) {ℜ}_{{n}_{tr}}^{tr} ( 𝒢 ) )$$
with a probability of 1−δ.
